(19) United States
(12) Patent Application Publication
(10) Pub. No.: US 2022/0245805 A1
(43) Pub. Date: Aug. 4, 2022

(54) MULTI WEED DETECTION

(71) Applicant: BASF Agro Trademarks GmbH, Ludwigshafen am Rein (DE)

(72) Inventors: Joerg WILDT, Köln (DE); Volker HADAMSCHEK, Köln (DE); Tim SCHAARE, Köln (DE); Maik ZIES, Köln (DE); Marek Piotr SCHIKORA, Köln (DE); Martin BENDER, Köln (DE)

(21) Appl. No.: 17/621,904

(22) PCT Filed: Jun. 29, 2020
(86) PCT No.: PCT/EP2020/068265

§ 371 Date: Dec. 22, 2021

(30) Foreign Application Priority Data
Jul. 1, 2019 (EP) 19183625.3

(51) Int. Cl. G06T 7/00; G06V 20/10; G06V 20/20; A01B 79/00; A01B 79/02; G06F 16/242; G06F 16/9538

(52) U.S. Cl. CPC G06T 7/0012; G06V 20/188; G06V 20/20; A01B 79/005; A01B 79/02; G06V 2201/10; G06F 16/9538; G06T 2200/24; G06T 2207/30168; G06T 2207/30188; G06F 16/2428

(57) ABSTRACT

In order to provide an efficient recognition method for agricultural applications, a decision-support device for agricultural object detection is provided. The decision-support device comprises an input unit configured for receiving an image of one or more agricultural objects in a field. The decision support system comprises a computing unit configured for applying a data driven model to the received image to generate metadata comprising at least one region indicator signifying an image location of the one or more agricultural objects in the received image and an agricultural object label associated with the at least one region indicator. The data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator. The decision support device further comprises an output unit, configured for outputting the metadata associated with the received image.

### FIELD OF THE INVENTION

The present invention relates to digital farming. In particular, the present invention relates to a decision-support device and a method for agricultural objection detection. The present invention further relates to a mobile apparatus, a computer program element, and a computer readable medium.

### BACKGROUND OF THE INVENTION

Current image recognition apps in the digital farming field focus on the detection of single weed species. In such algorithms, an image of a weed is taken, the image may be sent to a trained convolutional neural network (CNN) and a weed species is determined by the trained CNN. Recently enhanced CNN architectures were proposed that allow object detection networks depending on region proposal algorithms to hypothesize object locations. Region Proposal Network (RPN) that share full-image convolutional features with the detection network enable nearly cost free region proposals.

In agricultural applications, the weed environment is challenging for image recognition methods, since multiple plants on different backgrounds may occur in the field. Hence, depending on the image quality and the environment, the algorithmic confidence for weed detection can suffer. Particularly for multiple plants on the image, such algorithms need to discriminate not only plant and environment but also the plant themselves. Plants may be overlaid in the image making any shape-based extraction from the image difficult.

### SUMMARY OF THE INVENTION

There may be a need to provide an efficient recognition method in agricultural application.

The object of the present invention is solved by the subject-matter of the independent claims, wherein further embodiments are incorporated in the dependent claims. It should be noted that the following described aspects of the invention apply also for the decision-support device, the method, the mobile apparatus, the computer program element, and the computer readable medium.

A first aspect of the present invention provides a decision-support device for agricultural object detection, comprising:
an input unit, configured for receiving an image of one or more agricultural objects in a field;
a computing unit, configured for applying a data driven model to the received image to generate metadata comprising at least one region indicator signifying an image location of the one or more agricultural objects in the received image and an agricultural object label associated with the at least one region indicator,
wherein the data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator; and
an output unit, configured for outputting the metadata associated with the received image.

In other words, a decision support device is proposed for recognizing agricultural objects like weed, leaf damage, disease, or nitrogen deficiency in an image of an agricultural field. The device is based on a data driven model, such as CNN, with ‘attention’ mechanisms. The clue here lies in the agricultural region indicator included into the training data of the data driven model. Image background is not important, and no discrimination is required. Such data driven model enables fast and efficient processing even on a mobile device such as a smart phone. On training, images with multiple agricultural objects (e.g., weeds, diseases, leaf damages) are collected and annotated. The annotation includes a region indicator e.g. in form of a rectangular box marking each agricultural object and respective agricultural object label, such as weed species, surrounded by the box. For some agricultural objects, such as disease or nitrogen deficiency recognition, the region indicator may be a polygon for better delineating the contour of the disease or nitrogen deficiency. Once the data driven model is trained and adheres to predefined quality criteria, it will either be made available on a server (cloud) or a mobile device. In the latter case compression may be required, e.g. via node or layer reduction taking out those nodes or layers not triggered that often (in <x % of processed images). With such ‘attention’ mechanism using region indicator, the decision support device can differentiate multiple agricultural objects even on different backgrounds in the field. Thus, the efficiency of recognizing multiple agricultural objects, such as weeds, can be improved.

According to an embodiment of the present invention, the data driven model is configured to have been evaluated with a test dataset to generate a quality report including a quality in terms of confidence and a potential mixed-up of agricultural objects. The test dataset comprises multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator.

In other words, the annotated data may be separated into a training data and test data set. To enable appropriate testing of the trained network, the test data has to cover different agricultural objects. For multi weed detection, for example, the test data has to cover different weed species, ideally all weed species the network is trained upon. A quality report in the test data results will include the quality in terms of confidence and potential mix-up of weeds species. For example, if two weed species look very similar at one growth stage and can only be discriminated at a later growth stage or two weed species look similar and are hard to distinguish, a mix-up may happen. Such weed species need to be identified to e.g. produce further data sets for training.

According to an embodiment of the present invention, the one or more agricultural objects comprise at least one of a leaf damage, a disease and a nitrogen deficiency.

According to an embodiment of the present invention, the one or more agricultural objects comprise a weed.

According to an embodiment of the present invention, at least one set of examples further comprises a growth stage of the weed. The generated metadata further comprises the growth stage of the weed.

In other words, apart from region indicator and weed species, the data driven model may also be trained on weed growth stage. The growth stage of the weed may be relevant for determining an application rate of an herbicide.

According to an embodiment of the present invention, the computing unit is further configured to determine a weed density of the weed. The computing unit is further configured to determine to treat the weed with an herbicide, if it is determined that the weed density of the weed exceeds a threshold.

Together with the recognized weed from the data driven model, a weed density may be determined for each weed. Weed density can be used to further determine, if the field needs to be treated with an herbicide, e.g. if a threshold is exceeded.

According to an embodiment of the present invention, the computing unit is further configured to recommend, based on the agricultural object label associated with the weed, a specific herbicide product for treating the weed, preferably with an application rate derived from the weed density and the weed growth stage of the weed. The generated metadata further comprises at least one of the following information: whether the weed needs to be treated with an herbicide, the recommended specific herbicide product, and the application rate.

In other words, additionally, based on the recognized weed specific herbicide products may be recommended. The respective application rates may be derived based on weed density, weed growth stage and so on. This information can guide the user not only to recognize the weed species in the field but also to treat the weed.

According to an embodiment of the present invention, the decision-support device further comprises a web server unit, configured for interfacing with a user via a webpage and/or an application program served by the web server. The decision-support device is configured to provide a graphical user interface, GUI, to a user, by the webpage and/or the application program such that the user can provide an image of one or more agricultural objects in a field to the decision-support device and receive metadata associated with the image from the decision-support device.

In other words, the decision-support device may be a remote server that provides a web service to facilitate agricultural object detection in a field. The remote server may have a more powerful computing power to provide the service to multiple users to perform agricultural object detection in many different fields. The remote server may include an interface through which a user can authenticate (e.g. by providing a username and password), and use this interface to upload an image captured in a field to the remote server for performing analysis and receive associated metadata from the remote server.

A further aspect of the present invention provides a mobile apparatus, comprising:
a camera, configured for capturing an image of one or more agricultural objects in a field;
a processing unit, configured for:
i) being a decision-support device according to any one of claims 1 to 8 for providing metadata associated with the captured image; and/or
ii) providing a graphical user interface, GUI, to a user, via a webpage and/or an application program served by a decision-support device according to any one of claims 1 to 8 to allow the user to provide the captured image to the decision-support device and to receive metadata associated with the captured image from the decision-support device; and
   a display, configured for displaying the captured image and the associated metadata.

In other words, the data driven model may be made available on a server (cloud). In this case, the mobile apparatus, e.g. mobile phone or tablet computer, takes an image of an area of a field with its camera, the image is then sent to the decision-support device configured to be a remote server, and one or more agricultural objects are identified by the remote server. The corresponding results are sent to the mobile apparatus for being displayed to the user. Alternatively or additionally, the data driven model may be made available to the mobile apparatus. In this case compression may be required, e.g. via node or layer reduction taking out those nodes or layers not triggered that often (in <x % of processed images).

According to an embodiment of the present invention, the processing unit is further configured for performing a quality check on the captured image before providing the captured image to the decision-support device. The quality check comprises checking at least one of an image size, a resolution of the image, a brightness of the image, a blurriness of the image, a sharpness of the image, a focus of the image, and filtering junk from the captured image.

In other words, the image may be checked on a coarse basis to filter junk (e.g. Coca Cola bottle) from the images. Additional quality criteria may be checked such as image size, resolution, brightness, blurriness, sharpness, focus and so on. Once the image passed the quality check it is fed to the input layer of the trained data driven model. On the output layer region indicators for each detected agricultural object and respective labels including confidence level are provided.

According to an embodiment of the present invention, the processing unit is further configured for overlaying the at least one region indicator on the associated one or more agriculture objects in the captured image, preferably with the associated agricultural object label.

According to an embodiment of the present invention, the processing unit is further configured for producing an augmented reality image of a field environment that comprises one or more agricultural objects, each agricultural object being associated with a respective agricultural object label and preferably a respective region indicator overlaid on the augmented reality image.

To enhance the applicability of weed detection augmented reality and two-dimensional area measurements may be used. Examples of the algorithms to enable augmented reality and area measurements include, but not limited to, i) Marker-less AR: Key algorithms include visual odometry and visual-inertial odometry. ii) Marker-less AR with geometric environment understanding: Here, in addition to localizing the camera, a dense 3D reconstruction of the environment is provided. Key algorithms include dense 3D reconstruction, multi-view stereo literature. iii) Marker-less AR with geometric and semantic environment understanding: Here, in addition to having a dense 3D reconstruction, labels for those surfaces are provided. Key algorithms are sematic segmentation object detection 3D object localization.

A further aspect of the present invention provides a method for agricultural object detection, comprising:

a) receiving an image of one or more agricultural objects in a field;

b) applying a data driven model to the received image to create metadata comprising at least one region indicator signifying an image location of the one or more agricultural objects in the received image and an agricultural object label associated with the at least one region indicator,
wherein the data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator; and

c) outputting the metadata associated with the received image.

A further aspect of the present invention provides a computer program element for instructing an apparatus, which, when being executed by a processing unit, is adapted to perform the the method.

A further aspect of the present invention provides a computer readable medium having stored the program element.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 schematically shows an example of a decision support device for agricultural objection detection.

FIG. 2A shows an example of a graphical user interface (GUI) provided by the decision support device.

FIG. 2B shows an example of a screenshot of an image captured by a mobile phone.

FIG. 2C shows a drop list that is lodged when the user selects the region indicator.

FIG. 3 schematically shows an example of a mobile apparatus.

FIG. 4 schematically shows a further example of a mobile apparatus.

FIG. 5 shows a flow chart illustrating a method for agricultural object detection.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

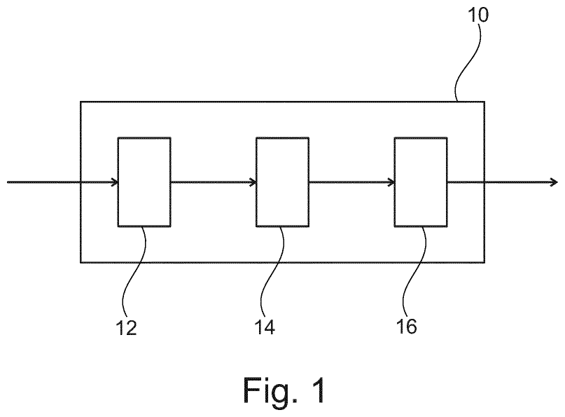

FIG. 1 schematically shows a decision support device 10 for agricultural objection detection. The decision support device 10 comprises an input unit 12, a computing unit 14, and an output unit 16.

The input unit 12 is configured for receiving an image of one or more agricultural objects in a field. The one or more agricultural objects may comprise at least one of a leaf damage, a disease, a nitrogen deficiency, and a weed. For simplicity, in the illustrated examples, only weeds are shown as an example of the agricultural objects. A skilled person will appreciate that the decision support device and the method described here are also applicable to other agricultural objects, such as leaf damages, diseases, and nitrogen deficiencies.

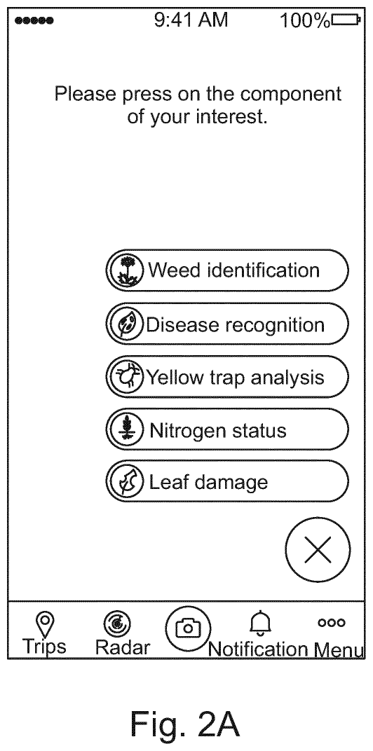

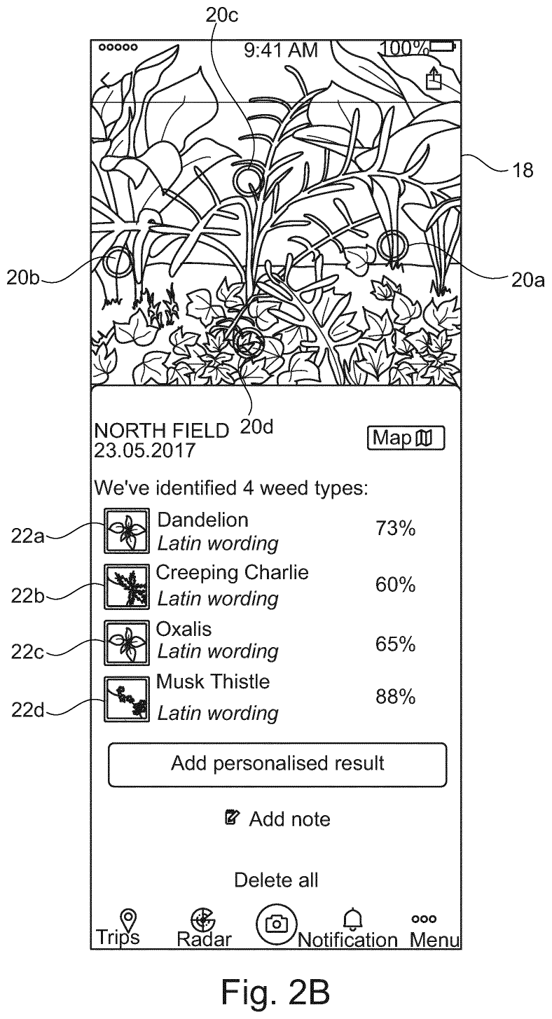

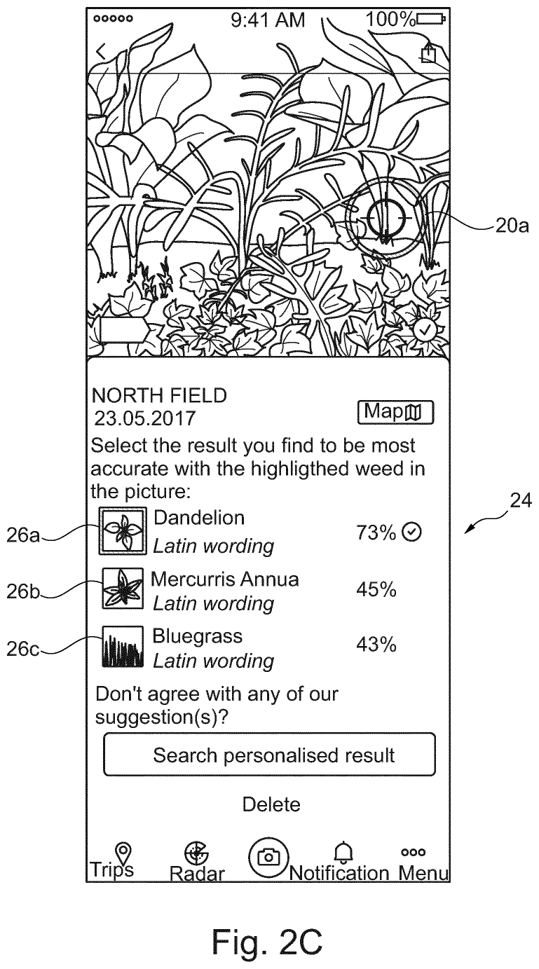

The decision support device 10 may provide an interface that allows a user to select one or more agricultural objects to be detected. FIG. 2A shows an example of a graphical user interface (GUI) provided by the decision support device, which allows a user to select one or more agricultural objects from a list of weed identification, disease recognition, yellow trap analysis, nitrogen status, and leaf damage. Once the user selects an agricultural object to be detected, e.g. weed identification in FIG. 2A, the GUI may guide the user to take a photo of an area in the field. An example of the photo is illustrated in FIG. 2B, which shows an example of a screenshot of an image 18 captured by a mobile phone. The image 18 comprises multiple plants on different backgrounds in the field.

Returning to FIG. 1, the computing unit 14 is configured for applying a data driven model to the received image to generate metadata comprising at least one region indicator signifying an image location of the one or more agricultural objects in the received image and an agricultural object label associated with the at least one region indicator. The data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator. On training, images with multiple agricultural objects are collected and annotated. The annotation includes region indicator e.g. in form of a rectangular box marking each weed and respective weed species surrounded by the box. The annotated data is separated into a training data and test data set. To enable appropriate testing of the trained network, the test data has to cover different agricultural objects. A quality report in the test data results will include the quality in terms of confidence and potential mix-up of weeds species.

In the example of the photo in FIG. 2B, four region indicators 20a, 20b, 20c, 20d, are identified and overlaid on the original input image. The region indicators 20a, 20b, 20c, 20d are displayed including labels 22a, 22b, 22c, 22d. In the example of FIG. 2B, the region indicators 20a, 20b, 20c, 20d are displayed as circles around each recognized agriculture object. The region indicators 20a, 20b, 20c, 20d may be marked with a color-coded indicator. The labels 22a, 22b, 22c, 22d, in the example of FIG. 2B, show the weed species including Dandelion, Creeping Charlie, Oxalis, and Musk Thistle. A confidence level may also be attached to each label including 73%, 60%, 65%, and 88%. It is noted that not all labels may be displayed. For example, if the highest confidence level on one box label is >50% this will be displayed.

For each indicator, a drop list may be lodged, which pops open on a touch screen in response to a tapping gesture by the user. Depending on output, the user may either confirm the agricultural objects with highest or lower confidence rank. Alternatively, the user may correct the labels of the agricultural objects. For example, in the example of FIG. 2C, a drop list is lodged when the user selects the region indicator 20a. The drop list comprises three agricultural object labels 26a, 26b, 26c that correspond the to the region indicator 20a with confidence rank. The user may correct the labels of the agricultural objects by selecting the desired label 26a in the example of FIG. 2C.

Returning to FIG. 1, the output unit is configured for outputting the metadata associated with the received image.

Optionally, the data driven model is configured to have been evaluated with a test dataset to generate a quality report including a quality in terms of confidence and a potential mixed-up of agricultural objects. The test dataset comprises multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator. Apart from region indicator and weed species, the data driven model may also be trained on weed growth stage. In other words, at least one set of examples further comprises a growth stage of the weed, and the generated metadata further comprises the growth stage of the weed. The weed density may be used to further determine, whether the field needs to be treated with an herbicide, if

If the agricultural objects to be detected are weeds, the computing unit 14 is further configured to determine a weed density of the weed. The computing unit is further configured to determine to treat the weed with an herbicide, if it is determined that the weed density of the weed exceeds a threshold, e.g. if a threshold is exceeded.

Optionally, the computing unit 14 is further configured to recommend, based on the agricultural object label associated with the weed, a specific herbicide product for treating the weed, preferably with an application rate derived from the weed density and the weed growth stage of the weed. The generated metadata further comprises at least one of the following information: whether the weed needs to be treated with an herbicide, the recommended specific herbicide product, and the application rate. For example, the decision support device may be coupled to a database that stores a list of specific herbicide products for various weed species.

The decision support device 10 may be embodied as, or in, a mobile apparatus, such as a mobile phone or a tablet computer. Alternatively, the decision support device may be embodied as a server that communicatively coupled to a mobile apparatus for receiving the image and outputting an analysis result to a mobile device. For example the decision support device may have a web server unit configured for interfacing with a user via a webpage and/or an application program served by the web server. The decision-support device is configured to provide a graphical user interface, GUI, to a user, by the webpage and/or the application program such that the user can provide an image of one or more agricultural objects in a field to the decision-support device and receive metadata associated with the image from the decision-support device.

The decision support device 10 may comprise one or more microprocessors or computer processors, which execute appropriate software. The processor of the device may be embodied by one or more of these processors. The software may have been downloaded and/or stored in a corresponding memory, e.g. a volatile memory such as RAM or a non-volatile memory such as flash. The software may comprise instructions configuring the one or more processors to perform the functions described with reference to the processor of the device. Alternatively, the functional units of the device, e.g., the processing unit, may be implemented in the device or apparatus in the form of programmable logic, e.g., as a Field-Programmable Gate Array (FPGA). In general, each functional unit of the system may be implemented in the form of a circuit. It is noted that the decision support device 10 may also be implemented in a distributed manner, e.g. involving different devices or apparatuses.

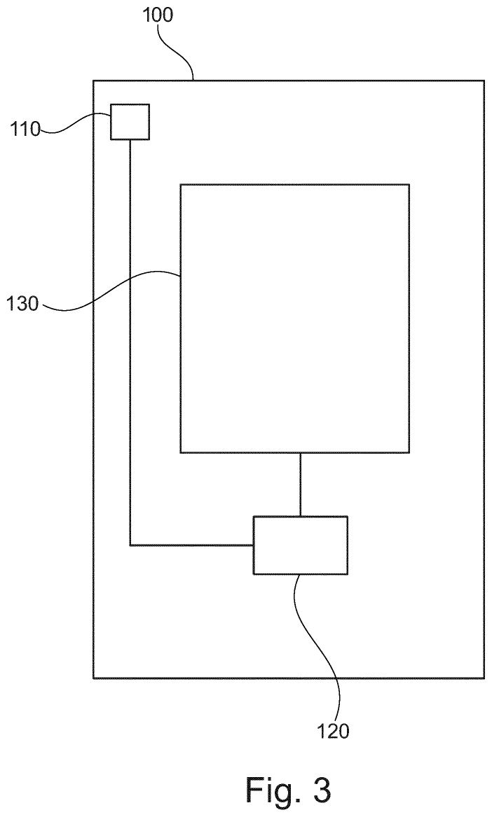

FIG. 3 schematically shows a mobile apparatus 100, which may be e.g., a mobile phone or a tablet computer. The mobile apparatus 100 comprises a camera 110, a processing unit 120, and a display 130.

The camera 110 is configured for capturing an image of one or more agricultural objects in a field.

The processing unit 120 is configured for being a decision-support device as describe above and below. In other words, the data driven model may be made available on the mobile apparatus. The compression may be required, e.g. via node or layer reduction taking out those nodes or layers not triggered that often (in <x % of processed images). Optionally, the processing unit 120 is further configured for overlaying the at least one region indicator on the associated one or more agriculture objects in the captured image, preferably with the associated agricultural object label. An example of the overlaid image is illustrated in FIG. 2B.

The display 130, such as a touch screen, is configured for displaying the captured image and the associated metadata.

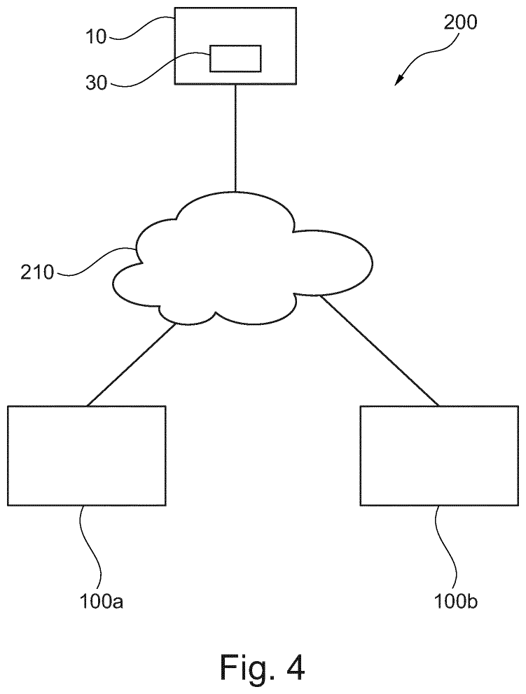

Additionally or alternatively, the data support device 10 may be embodied as a remote server as shown in FIG. 4 in a system 200. The system 200 of the illustrated example comprises a plurality of mobile apparatus 100, such as mobile apparatuses 100a, 100b, a network 210, and a decision support device 10. For simplicity, only two mobile apparatuses 100a, 100b are illustrated. However, the following discussion is also scalable to a large number of mobile apparatuses.

The mobile apparatuses 100a, 100b of the illustrated example may be a mobile phone, a smart phone and/or a tablet computer. In some embodiments, the mobile apparatuses 100a, 100b may also be referred to as clients. Each mobile apparatus 100a, 100b may comprise a user interface like a touch screen configured to facilitate one or more users to submit one or more images captured in the field to the decision support device. The user interface may be an interactive interface including, but not limited to, a GUI, a character user interface and a touch screen interface.

The decision support device 10 may have a web server unit 30 that provides a web service to facilitate management of image data in the plurality of mobile apparatuses 100a, 100b. In some embodiments, the web server unit 30 may interface with users e.g. via webpages, desktop apps, mobile apps to facilitate the user to access the decision support device 10 to upload captured images and receive associated metadata. Alternatively, the web server unit 30 of the illustrated example may be replaced with another device (e.g. another electronic communication device) that provides any type of interface (e.g. a command line interface, a graphical user interface). The web server unit 30 may also include an interface through which a user can authenticate (by providing a username and password).

The network 210 of the illustrated example communicatively couples the plurality of mobile apparatuses 100a, 100b. In some embodiments, the network 210 may be the internet. Alternatively, the network 210 may be any other type and number of networks. For example, the network 210 may be implemented by several local area networks connected to a wide area network. Of course, any other configuration and topology may be utilized to implemented the network 210, including any combination of wired network, wireless networks, wide area networks, local area networks, etc.

The decision support device 10 may analyze the image submitted from each mobile apparatus 100a, 100b and return the analysis results to the respective mobile apparatus 100a, 100b.

Optionally, the processing unit 120 of the mobile apparatus may be further configured for performing a quality check on the captured image before providing the captured image to the decision-support device. The quality check comprises checking at least one of an image size, a resolution of the image, a brightness of the image, a blurriness of the image, a sharpness of the image, a focus of the image, and filtering junk from the captured image.

Optionally, the processing unit 120 is further configured for producing an augmented reality image of a field environment that comprises one or more agricultural objects, each agricultural object being associated with a respective agricultural object label and preferably a respective region indicator overlaid on the augmented reality image. For example, the agricultural object recognition may be implemented as an online/real-time functionality in combination with the augmented reality. Hence, the mobile phone camera is used to produce an augmented reality image of the field environment, the data drive driven model processes each image of the sequence and the recognized weed labels and optionally region indicators are overlaid on the augmented reality image.

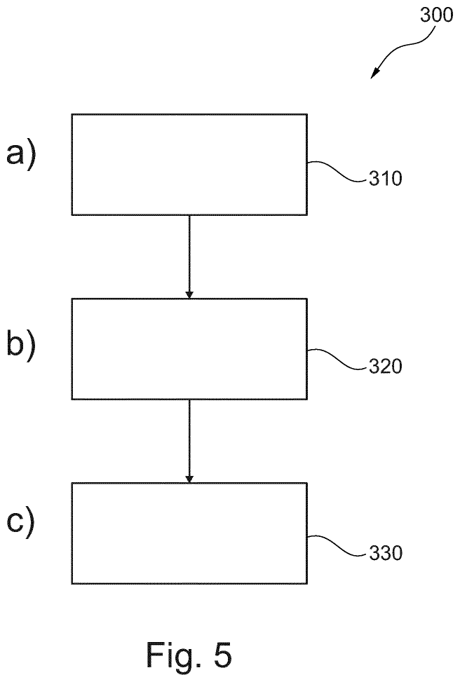

FIG. 5 shows a flow chart illustrating a method 300 for agricultural object detection. In step 310, i.e. step a), an image of one or more agricultural objects in a field is received. For example, a mobile phone camera may capture an image of multiple weeds, or leaf damages in an area of the field.

In step 320, i.e. step b), a data driven model is applied to the received image to create metadata comprising at least one region indicator signifying an image location of the one or more agricultural objects in the received image and an agricultural object label associated with the at least one region indicator. The data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator.

In step 330, i.e. step c), the metadata associated with the received image is output.

It will be appreciated that the above operation may be performed in any suitable order, e.g., consecutively, simultaneously, or a combination thereof, subject to, where applicable, a particular order being necessitated, e.g., by input/output relations.

In another exemplary embodiment of the present invention, a computer program or a computer program element is provided that is characterized by being adapted to execute the method steps of the method according to one of the preceding embodiments, on an appropriate system. The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A decision-support device (10) for agricultural object detection, the decision-support device comprising:
an input unit (12), configured for receiving an image (18) of one or more agricultural objects in a field;
a computing unit (14), configured for applying a data driven model to the received image to generate metadata comprising at least one region indicator (20a, 20b, 20c, 20d) signifying an image location of the one or more agricultural objects in the received image and an agricultural object label (22a, 22b, 22c, 22d) associated with the at least one region indicator, wherein the data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator; and
an output unit (16), configured for outputting the metadata associated with the received image.

2. The decision-support device according to claim 1,
wherein the data driven model is configured to have been evaluated with a test dataset to generate a quality report including a quality in terms of confidence and a potential mixed-up of agricultural objects; and
wherein the test dataset comprises multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator.

3. The decision-support device according to claim 1,
wherein the one or more agricultural objects comprise at least one of a leaf damage, a disease, or a nitrogen deficiency.

4. The decision-support device according to claim 1, wherein the one or more agricultural objects comprise a weed.

5. The decision-support device according to claim 4, wherein at least one set of examples further comprises a growth stage of the weed and wherein the generated metadata further comprises the growth stage of the weed.

6. The decision-support device according to claim 4,
wherein the computing unit is further configured to determine a weed density of the weed; and
wherein the computing unit is further configured to determine to treat the weed with an herbicide, if it is determined that the weed density of the weed exceeds a threshold.

7. The decision-support device according to claim 6,
wherein the computing unit is further configured to recommend, based on the agricultural object label associated with the weed, a specific herbicide product for treating the weed, preferably with an application rate derived from the weed density and growth stage of the weed, and
wherein the generated metadata further comprises at least one of the following information:
whether the weed needs to be treated with an herbicide;
the recommended specific herbicide product; or
the application rate.

8. The decision-support according to claim 1, further comprising:
a web server unit (30), configured for interfacing with a user via a webpage and/or an application program served by the web server,
wherein the decision-support device is configured to provide a graphical user interface, GUI, to a user, by the webpage and/or the application program such that the user can provide an image of one or more agricultural objects in a field to the decision-support device and receive metadata associated with the image from the decision-support device.

9. A mobile apparatus (100), comprising:
a camera (110), configured for capturing an image of one or more agricultural objects in a field;
a processing unit (120), configured to:
i) implement the functionality of the decision-support device according to claim 1 and to provide metadata associated with the captured image; and/or
ii) provide a graphical user interface, GUI, to a user, via a webpage and/or an application program served by the decision-support device to allow the user to provide the captured image to the decision-support device and to receive metadata associated with the captured image from the decision-support device; and
a display (130), configured for displaying the captured image and the associated metadata.

10. The mobile apparatus according to claim 9,
wherein the processing unit is further configured for performing a quality check on the captured image before providing the captured image to the decision-support device, and
wherein the quality check comprises checking at least one of an image size, a resolution of the image, a brightness of the image, a blurriness of the image, a sharpness of the image, a focus of the image, or filtering junk from the captured image.

11. The mobile apparatus according to claim 9,
wherein the processing unit is further configured for overlaying the at least one region indicator on the associated one or more agriculture objects in the captured image.

12. The mobile apparatus according to claim 9,
wherein the processing unit is further configured for producing an augmented reality image of a field environment that comprises one or more agricultural objects, each agricultural object being associated with a respective agricultural object label and preferably a respective region indicator overlaid on the augmented reality image.

13. A method (300) for agricultural object detection, the method comprising:
a) receiving (310) an image of one or more agricultural objects in a field;
b) applying (320) a data driven model to the received image to create metadata comprising at least one region indicator signifying an image location of the one or more agricultural objects in the received image and an agricultural object label associated with the at least one region indicator, wherein the data driven model is configured to have been trained with a training dataset comprising multiple sets of examples, each set of examples comprising an example image of one or more agricultural objects in an example field and associated example metadata comprising at least one region indicator signifying an image location of the one or more agricultural objects in the example image and an example agricultural object label associated with the at least one region indicator; and
c) outputting (330) the metadata associated with the received image.

14. A non-transitory, computer-readable medium having instructions encoded thereon that, when executed by a processing unit, cause the processing unit to perform the method of claim 13.

15. (canceled)
